(19) United States
(12) Patent Application Publication
(10) Pub. No.: US 2010/0000383 A1
(43) Pub. Date: Jan. 7, 2010

(54) Microscope coupled tissue sectioning system

(76) Inventors: David S. Koos, Temple City, CA (US); John M. Choi, Pasadena, CA (US)

Correspondence Address: TOPE-MCKAY & ASSOCIATES;CARY TOPE-MCKAY, 23852 Pacific Coast Highway #311, Malibu, CA, 90265, US

(21) Appl. No.: 12/583,471

(22) Filed: Aug. 21, 2009

Related U.S. Application Data
(63) Continuation-in-part of application No. 12/188,076, filed on Aug. 7, 2008.
(60) Provisional application No. 60/963,763, filed on Aug. 7, 2007.
(60) Provisional application No. 61/189,641, filed on Aug. 21, 2008.

(51) Int. Cl. B26D 7/08; B26D 7/06; G06K 9/00

(52) U.S. Cl. 83/22; 83/78; 83/168; 382/128

(57) ABSTRACT

The present invention relates to a microscope coupled tissue sectioning system. The tissue sectioning system includes a frame for coupling with a microscope. A sample cutting apparatus is attached with the frame. The sample cutting apparatus includes a sample cutter (e.g., blade) and is operable for causing the sample cutter to engage with the sample and remove a portion of the sample. Additionally, a sample moving apparatus attached with the frame. The sample moving apparatus is operable for causing the sample to align with an imaging path of a microscope for imaging by the microscope.

### PRIORITY CLAIM

The present application is a Continuation-in-Part application of U.S. application Ser. No. 12/188,076, filed on Aug. 7, 2008, entitled, “Vibratome Assisted Subsurface Imaging Microscopy (VIBRA-SSIM),” which is a non-provisional application of U.S. Provisional Application No. 60/963,763, filed on Aug. 7, 2007. The present application is ALSO a non-provisional application of U.S. Provisional Application No. 61/189,641, filed on Aug. 21, 2008, entitled, “A Fluorescent Protein Compatible Miniature Microscope Stage Mounted Tissue Sectioning System that Enables Extended 3-D Volume Microscopy of Large Biological Samples.”

### GOVERNMENT RIGHTS

The U.S. Government has certain rights in this invention pursuant to Grant No. EY018241 awarded by the National Institutes of Health.

### FIELD OF INVENTION

The present invention relates to a three-dimensional volume microscopy and, more particularly, to a microscope coupled tissue sectioning system that enables extended three-dimensional volume microscopy of large biological samples.

### BACKGROUND OF INVENTION

Determining the three-dimensional (3-D) organization of whole biological samples is fundamental to understanding biological form and function and for evaluating pathological states. This type of imaging can be useful for practitioners and teachers in all areas of the life sciences including the fields of anatomy, pathology, neurology, surgical guidance, histology, and developmental biology. 3-D reconstructions are ideally suited to the analysis of tissues and organs with complex structures where two-dimensional views fail to give an adequate representation and mental visualization is difficult. 3-D reconstructions provide valuable insight into the interconnectivity and interdependencies within a sample. The ultimate utility of these 3-D datasets depends on the level of detail contained and the relative precision to which the original geometry is preserved in the resultant dataset. Unfortunately, the field-of-view of current high-resolution imaging tools is often much smaller than the region of interest. Extended volume imaging techniques allow multiple, overlapping regions to be collected to reconstruct a volume much larger than the field-of-view with high resolution.

To overcome the limits of the microscope field-of-view, extended 3-D volume imaging techniques have been developed in order to capture a high-resolution (sub-cellular) visualization of the entire sample. This is done by imaging laterally and vertically adjacent regions of a sample at high-resolution and then merging the volume images along adjacent, possibly overlapping, boundaries to form a composite high-resolution 3-D reconstruction of the entire sample. Two types of implementations of this technology have been employed: Section-Based and Block-Based.

Section-based imaging is the method traditionally used in histology and involves cutting the sample into thin sections with a microtome, preparing each thin section, and imaging each section separately under a microscope. As shown in FIG. 1, the section-based approach typically entails 6 steps. These steps are enumerated below.
1. Sample sectioning 100: Physically cut and collect large serial sections throughout a large macroscopic sample.
2. Tiled Imaging of a single large section 102: Optically image adjacent lateral subregions (referred to as tiles) within each section using either wide-field microscopy or laser scanning microscopy. This process is repeated on adjacent sub-regions until the entire region of interest in the large section is completely covered by tiles of images. Each tiled sub-region overlaps its adjacent tiles by a small amount (usually 10-30%) to ensure faithful image stitching.
3. Stitching and registration to make a sectional montage 104: The tiles of lateral-adjacent subregions are stitched together to make a sectional montage representing the entire section.
4. Repeat steps 2-3 for all the large physical sections of the macroscopic sample 106: Repeat tiled-imaging for each large section and prepare sectional montages for each.
5. Stitch together overlying sectional montages to generate a composite stack 108: Align each sectional montage with the its underlying sectional montage and stitch them together into one large composite stack of sectional montages.
6. Reconstruct the composite stack of sectional montages into a 3-D volume 110: This composite stack of sectional montages can be computer reconstructed into a final 3-D volume that represents the entire sample in 3-D.

This tedious, time consuming technique is very labor intensive, sometimes requiring several days, and suffers from several drawbacks. First, because each section is processed serially but separately, the original geometry and alignment of the tissue is lost and therefore will require substantial effort to re-align or register the information in the section montages prior to generating the final 3-D reconstruction. To further complicate the process, handling the sections one by one often leads to physical distortions that alter the original tissue geometries. Finally, the physical act of sectioning destroys tissue at the sectioned surfaces. These destruction zones are lost data and will appear as gaps between the section montages when they are combined into the final 3-D reconstruction. These problems drastically reduce the effectiveness of section-based approaches for high resolution extended 3-D volume imaging.

Block-based approaches to extended 3-D volume imaging have been developed in order to overcome the alignment problems and data loss associated with section-based approaches. Rather than cutting a macroscopic sample into large sections and then imaging those sections separately one-by-one, block-based approaches image the surface of the macroscopic sample while it is still connected to the underlying portion of the sample. In such block-based approaches, the sectioned face of the macroscopic sample is tiled and imaged directly with either wide-field microscopy or laser scanning microscopy. Once the entire block face has been tiled and all the laterally-adjacent subregions are imaged, those adjacent tiles can be stitched together to form a sectional montage. Then a set thickness of the sample is sectioned off and discarded. This exposed new surface is ready for the next round of tiled imaging and generation of the next sectional montage. The process is repeated until the entire macroscopic sample is represented by a stack of overlying sectional montages. Thereafter, the sectional montages are aligned into a composite stack that can be reconstructed into a high resolution 3-D volume representing the entire macroscopic sample. Iterations of tiled imaging and sectioning maintains the alignment of the tissue throughout the resultant tiled stacks of optical sections. The preservation of alignment reduces the need to re-align prior to generating a 3-D reconstruction and generally results in much better 3-D reconstructions.

Although block-based imaging schemes solve the problems of section-based imaging and have emerged as the most useful approach to date for extended 3-D volume imaging, prior implementations of block-based extended 3-D volume imaging employ an organic solvent based embedding procedure that is incompatible with the preservation of fluorescent protein fluorescence. This is a major drawback because fluorescent protein technology is currently a powerful and favored method for highlighting proteins, cells, and organs. Fluorescent protein tags are genetically encodeable so that no exogenous labels need to be applied. Furthermore, the availability of several, distinct colors allow multiple cells or structures to be analyzed in the sample, even simultaneously. Fluorescent proteins have already proven their effectiveness in studies of gene expression, protein localization, protein trafficking, cell migration and brain connectivity. However, the fluorescence of fluorescent proteins is very sensitive to organic solvent exposure, which is commonly used in block-based imaging. Many block-based histological schemes infiltrate and embed the tissue sample in resin, plastic or paraffin. Although the resin and paraffin provide a solid support for microtome sectioning, the infiltration process requires dehydration and exposure to organic solvents. Additionally, these organic solvents irreversibly alter the sample. Organic solvents cause macroscopic distortions, such as shrinkage, that change the original geometry of the tissue. The use of organic solvents can also extract cellular components and permanently damage the sample. In addition, some support matrix materials, such as paraffin based ones, exhibit strong autofluorescence at the wavelengths normally used for imaging fluorescent proteins. This autofluorescence of the matrix will obscure the fluorescent protein emission and impede the imaging process.

To overcome the obstacle provided by solvent exposure, Vibratome Assisted Sub-Surface Imaging Microscopy (VIBRA-SSIM) was devised. VIBRA-SSIM was disclosed in U.S. application Ser. No. 12/188,076, filed on Aug. 7, 2008, which is incorporated by reference as though fully set forth herein. VIBRA-SSIM is an aqueous, block-based extended 3-D volume imaging approach that is completely compatible with protein fluorescence, encounters low matrix autofluorescence and precisely maintains the original sample geometries.

The VIBRA-SSIM approach consists of an imaging technique adapted to aqueous embedded samples that may or may not be fixed, and a device for removing sections that have been imaged, allowing imaging of the next volume. The cutting device employs aqueous embedding and sectioning technologies and thus completely avoids the problems associated with organic processing. By avoiding organic processing the technology is completely compatible with fluorescent protein technology and the samples maintain their native hydrated biological geometries. Previous methods using non-aqueous matrices provide a rigidity and stiffness that preserves the sample face during mechanical sectioning with minimal distortion or damage. However, aqueous matrices are typically much softer, and the surface is more prone to damage requiring a new device and alternate cutting schemes than the typical diamond knife technique.

As shown in FIG. 2, the optical volume 200 is the total volume that can be imaged using purely optical volume imaging techniques, such as confocal or multi-photon laser scanning microscopy, without altering the sample. Due to the aqueous compatible cutting techniques, the sample surface may have damage or deformation that prevents accurate images to be collected at the surface, or portions of the sample may be destroyed in the cutting process and permanently lost. This volume is called the damaged volume 202. This is distinctly different than block-based imaging techniques that employ very rigid, resin embedding matrices and extremely sharp diamond blades to preserve the surface. In these cases, the surface remains minimally damaged due to the cutting, although they may still incorporate damage from the dehydration and non-aqueous embedding procedure. These techniques may capture only the surface image, in so-called surface imaging microscopy and imaging, or include the surface in the optical volume. However, these techniques would still lack compatibility with fluorescent proteins.

The damaged volume 202 in the technique includes the surface which may be damaged due to the mechanical separation of the attached sample material. By relegating any damaged tissue to this damaged volume which will not be included in the extended volume reconstruction, the challenge of imaging samples embedded in softer aqueous matrices can be solved. The damaged volume 202 can be very thin, and as aqueous compatible matrix or tissue sectioning system technologies improve, the damaged volume 202 can be adjusted to the minimal volume necessary to avoid surface damage. Below the damaged volume 202 is the image volume (or optical volume 200), which contains the high-resolution, sub-cellular optical image of the biological sample and will be a component of the final, composite, extended volume reconstruction.

A portion of the optical volume 200 will overlap 204 with the subsequent optical volume 200 that is adjacent in the axial, z-axis, dimension. This region is used for registration and provides redundant image data that is used to align and register the subsequent optical volume image data in the final composition. Since this overlap volume 204 is sampled twice at different distances from the objective, certain image degrading artifacts due to optical scattering that occurs deeper within tissue may be ameliorated. All optical-volume-imaging techniques suffer from degraded axial resolution due to scattering as the focal plane penetrates deeper into tissue. The second image acquisition occurs after tissue has been sectioned and removing, bringing the same volume of tissue closer to the surface, and thus the objective, reducing the amount of tissue that can cause scattering. For extended volume imaging, this overlap in the z-axis (shown in FIG. 1) along with overlapping boundaries in the x-y plane (shown in FIG. 3) will be used with widely used, existing tiling methods for volume registration. These imaging techniques are repetitively iterated until the entire sample has been imaged.

As shown in FIG. 3 and as noted above with respect to FIG. 1, tiled imaging 300 can be used to image in the x-y plane of laterally adjacent optical stacks 302 (i.e., T1, T2, T3 . . . ), resulting in a plurality of tiled images. In imaging laterally adjacent optical stacks 302, an overlap 304 exists between adjacent stacks. The overlap 304 allows for the plurality of tiled images to be stitched together to make a sectional montage 306 in the x-y plane.

While the VIBRA-SSIM method solves the problem of 3-D extended volume imaging in an aqueous medium that is compatible with fluorescent protein technology, its original implementation consisted of two separate devices (i.e., juxtaposed separate devices coupled by a light path), a aqueous tissue sectioning device and a laser scanning microscopy (LSM) microscope, or a completely custom engineered solution, such as light path, cutting device or LSM.

LSM can be used in block-based extended 3-D volume imaging. FIG. 4 illustrates the flow for performing block-based extended 3D volume imaging using LSM. At step 402, LSM allows the user to image a stack of optical sections. LSMs can collect optical sections by either rejecting out of focus signals with a pinhole (confocal) or specifically exciting only a restricted spatial position (multiphoton). Because of the restricted optical section, these techniques do not need the sample to be infiltrated with an opaque dye. At step 404, the top of the stack of images can be set to begin below the sectioned and destroyed block surface (i.e., the upper portion of the block surface is removed). Furthermore, by imaging a stack of optical section that is larger in depth than the thickness of the section that is sectioned off and discarded, one can achieve overlapping stacks of optical sections. These overlapping stacks do not include images of the destroyed block surfaces and thus no gaps in the data will be encountered. The process of imaging followed the removal of the upper portions is repeated at steps 406-410 until the entire block surface has been imaged. At step 412, the internal structures are aligned and registered. At step 414, the internal structures are stitched together thereby reconstructing the 3D image.

As evident above, some implementations of VIBRA-SSIM require the precise movement of a large, heavy, expensive vibrating microtome that has been coupled to a microscope. Due to the size and weight of the vibrating microtome, precisely and reproducibly positioning it with respect to the microscope objective can be difficult in some circumstances. Moving the microscope with respect to the vibrating microtome can be even more difficult.

Thus, in order to overcome this engineering challenge and to increase its accessibility/applicability to a larger number of laboratories, a continuing need exists for a tissue sectioning device and sample positioner that can be coupled to an existing microscope system with minimal modification, such as within the space reserved for the sample on the microscope stage itself. Such a modular microscope attachment will allow researchers to modify an existing Laser Scanning Microscope in order to perform volume imaging, such as VIBRA-SSIM style 3-D extended volume imaging.

### SUMMARY OF INVENTION

The present invention relates to a microscope coupled tissue sectioning system that enables extended three-dimensional volume microscopy of large biological samples. The microscope coupled tissue sectioning system comprises a frame for coupling with a microscope. The system can be stage mounted with a standard microscope stage which allows for a particular type of coupling that is very convenient to set up and cost effect. However, it is to be understood that the present invention is not intended to be limited thereto as any suitable form of coupling with the microscope is envisioned and enabled by the present invention.

A sample cutting apparatus is attached with the frame, the sample cutting apparatus having a sample cutter and being operable for causing the sample cutter to engage with the sample and remove a portion of the sample. The sample cutter is a cutting tool selecting from a group consisting of an oscillating blade and a hot wire. A sample moving apparatus is attached with the frame, the sample moving apparatus being operable for causing the sample to align with an imaging path of a microscope for imaging by the microscope.

In another aspect, an aqueous bath system is connected with the frame for mounting the sample. The aqueous bath system further includes a flow apparatus for allowing an aqueous bath to flow across the sample and move the portion of the sample that was removed by the sample cutting apparatus out of the imaging path. The flow apparatus includes an inlet, an outlet, and a pumping mechanism for pumping the aqueous bath to the sample via the inlet and/or away from the sample via the outlet.

In another aspect, the sample cutting apparatus includes a motor system that is operable for moving the sample cutter and sample in a manner selected from a group consisting of moving the sample cutter relative to the sample in the x-y axes and moving the sample relative to the sample cutter in x-y axes.

In yet another aspect, the sample cutting apparatus includes a motor system that is operable for moving the sample cutter and sample in a manner selected from a group consisting of moving the sample cutter relative to the sample in the z-axis and moving the sample relative to the sample cutter in the z-axis.

Further, the sample moving apparatus is operable for moving the sample relative to the imaging path in the z-axis when the frame is connected with a microscope.

As can be appreciated by one skilled in the art, the present invention also includes a method for forming and using the microscope coupled tissue section system. The method for forming the system comprises a plurality of acts of forming and assembling the various components described herein. The method for utilizing the system comprises a plurality of acts of performing the functions and operations described herein. For example, the method comprises acts of mounting a sample in an aqueous bath system; raising the sample to a height at which a sample cutter is capable of removing a section from the sample; sectioning off a top layer from the sample to create a z-axis origin; removing the top layer from the sample; adjusting an objective lens to bring the sample into focus; performing tiled imaging in an x-y plane of laterally adjacent optical stacks in the sample to generate tiled imaging data; repeating the acts of raising the sample through performing tiled imaging until a desired depth in the z-axis has been imaged; and processing the tiled imaging data to combine the data into a fully rendered volume between the z-axis origin and the desired depth in the z-axis.

As can be understood by one skilled in the art, other acts are also included that are natural acts based on the operational features of the microscope coupled tissue sectioning system described herein.

### BRIEF DESCRIPTION OF THE DRAWINGS

The objects, features and advantages of the present invention will be apparent from the following detailed descriptions of the various aspects of the invention in conjunction with reference to the following drawings, where:

FIG. 1 is a flowchart depicting section-based extended three-dimensional (3-D) volume imaging;

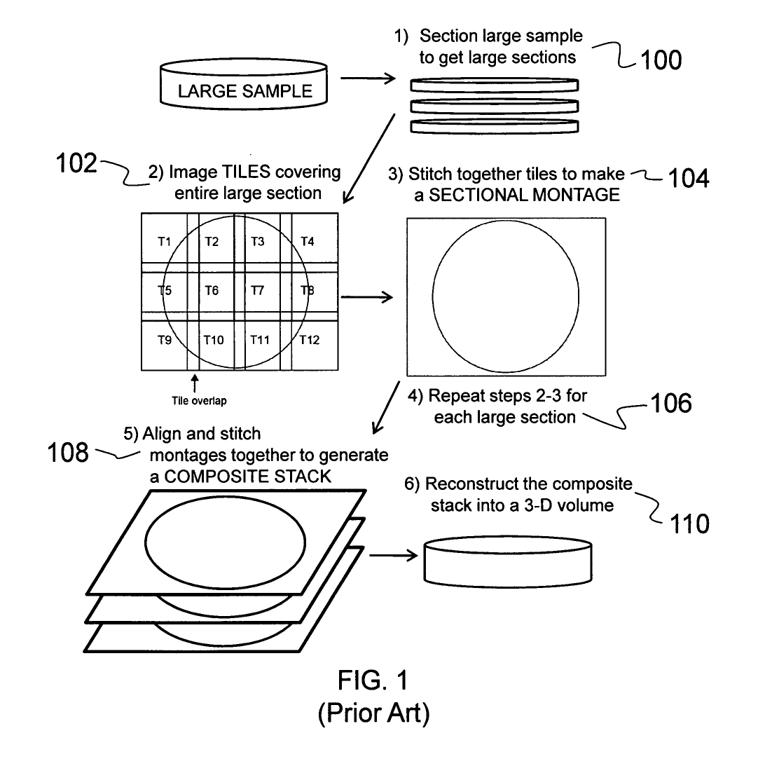

FIG. 2 is an illustration depicting z-axis reconstruction;

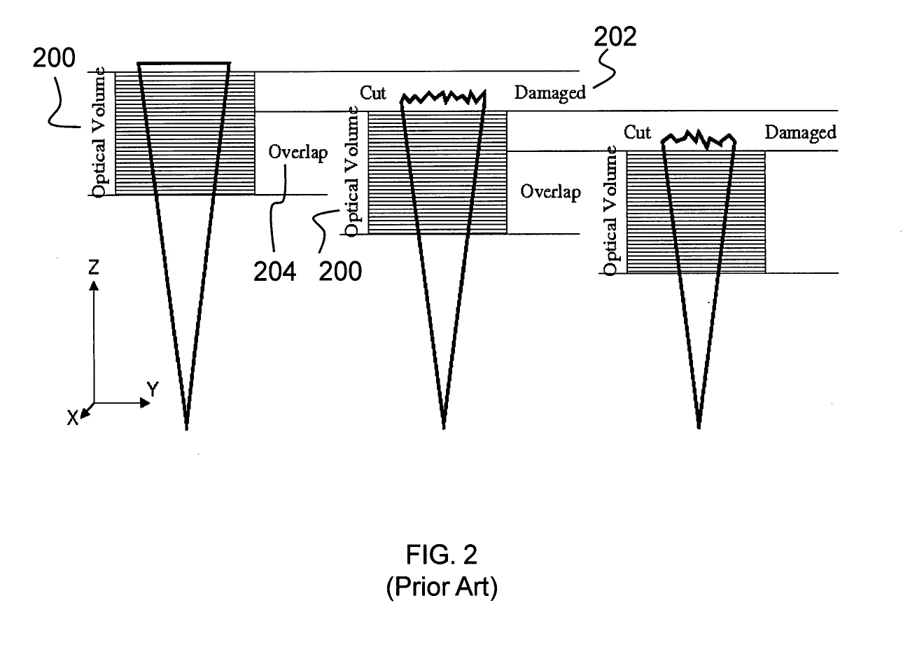

FIG. 3 is an illustration depicting x-y axis reconstruction;

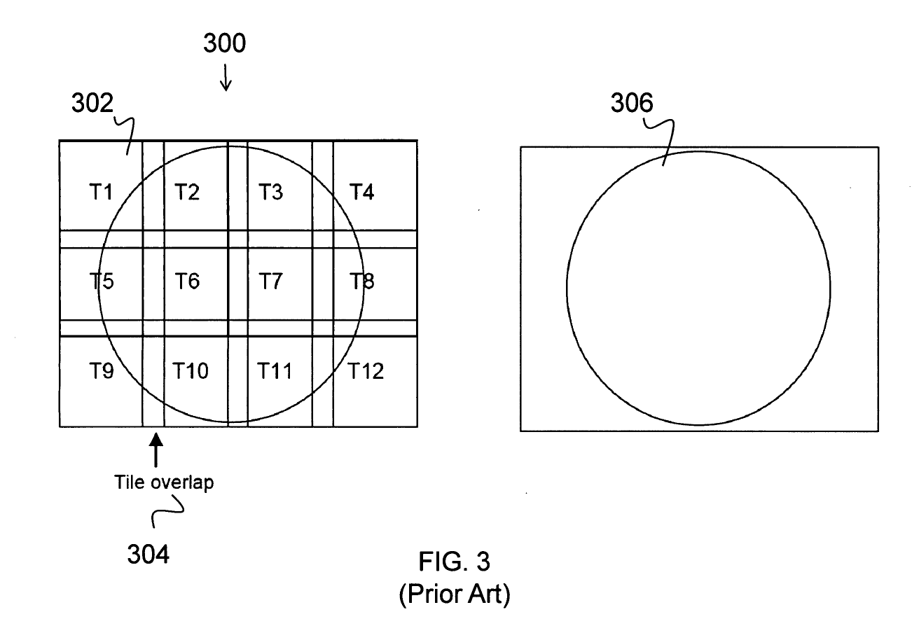

FIG. 4 is a flowchart depicting block-based extended 3-D volume imaging using a laser scanning microscope;

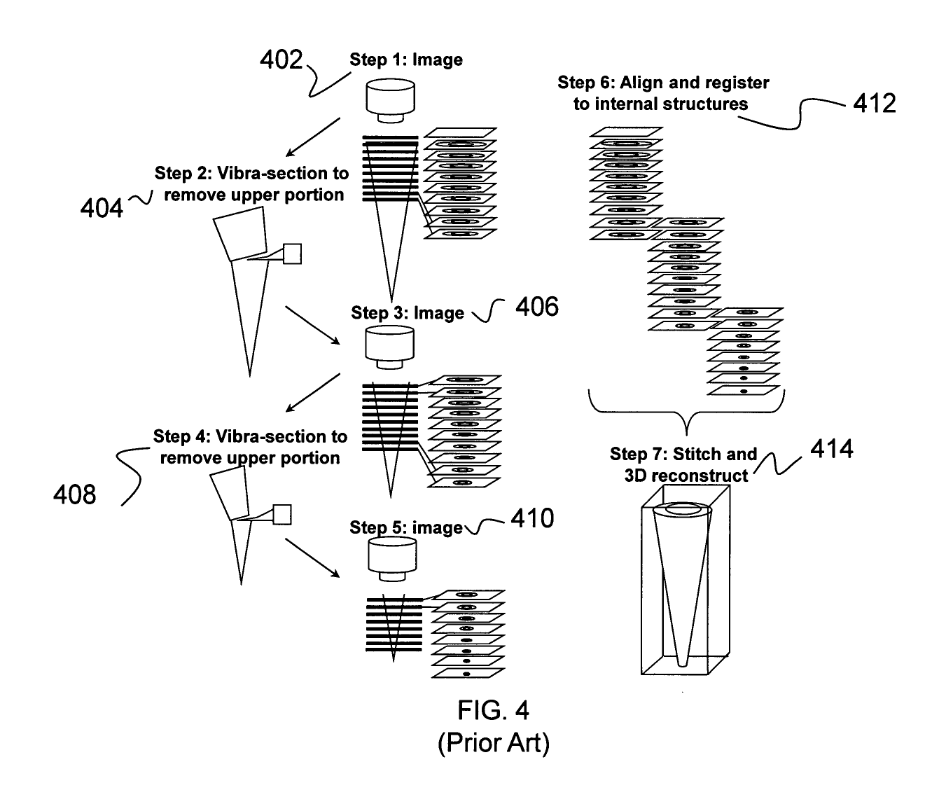

FIG. 5 is an illustration of a microscope stage and with an attached tissue sectioning system according to the present invention;

FIG. 6A is an illustration of tissue sectioning system according to the present invention;

FIG. 6B is an illustration of a tissue sectioning system according to the present invention;

FIG. 7A is a schematic of a sample positioned in the tissue sectioning system's bath according to the present invention;

FIG. 7B is a schematic of the tissue sectioning system mounted with a microscope stage, depicting an objective lens of the microscope being raised to provide space for the sample cutter to engage with the sample;

FIG. 7C is a schematic of the tissue sectioning system, depicting the sample being raised to a height at which the sample cutter can engage with the sample;

FIG. 7D is a schematic of the tissue sectioning system, depicting the sample cutter engaging with the sample to remove a portion of the sample;

FIG. 7E is a schematic of the tissue sectioning system, depicting the sample cutter as being separated from the sample, with an aqueous bath system being employed to allow an aqueous bath to flow across the sample and move the portion of the sample that was removed by the sample cutting apparatus out of the imaging path of the objective lens; and

FIG. 7F is a schematic of the tissue sectioning system, depicting the tiled imaging in the x-y plane of laterally adjacent optical stacks.

### DETAILED DESCRIPTION

The present invention relates to a three-dimensional volume microscopy and, more particularly, to a microscope coupled tissue sectioning system that enables extended three-dimensional volume microscopy of large biological samples. The following description is presented to enable one of ordinary skill in the art to make and use the invention and to incorporate it in the context of particular applications. Various modifications, as well as a variety of uses in different applications will be readily apparent to those skilled in the art, and the general principles defined herein may be applied to a wide range of embodiments. Thus, the present invention is not intended to be limited to the embodiments presented, but is to be accorded the widest scope consistent with the principles and novel features disclosed herein.

In the following detailed description, numerous specific details are set forth in order to provide a more thorough understanding of the present invention. However, it will be apparent to one skilled in the art that the present invention may be practiced without necessarily being limited to these specific details. In other instances, well-known structures and devices are shown in block diagram form, rather than in detail, in order to avoid obscuring the present invention.

The reader's attention is directed to all papers and documents which are filed concurrently with this specification and which are open to public inspection with this specification, and the contents of all such papers and documents are incorporated herein by reference. All the features disclosed in this specification, (including any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

Furthermore, any element in a claim that does not explicitly state “means for” performing a specified function, or “step for” performing a specific function, is not to be interpreted as a “means” or “step” clause as specified in 35 U.S.C. Section 112, Paragraph 6. In particular, the use of “step of” or “act of” in the claims herein is not intended to invoke the provisions of 35 U.S.C. 112, Paragraph 6.

Before describing the invention in detail, an introduction is provided to give the reader with a general understanding of the present invention. Next, details of the present invention are provided to give an understanding of the specific aspects.

(1) Introduction

The present invention is microscope coupled tissue sectioning system that enables extended three-dimensional (3-D) volume microscopy of large biological samples. Determining the 3-D organization of whole biological samples is fundamental to understanding biological form and function and for evaluating pathological states. This type of imaging can be useful for practitioners and teachers in all areas of the life sciences including the fields of anatomy, pathology, neurology, surgical guidance, histology, and developmental biology. 3-D reconstructions are ideally suited to the analysis of tissues and organs with complex structures where two-dimensional views fail to give an adequate representation and mental visualization is difficult. 3-D reconstructions provide valuable insight into the interconnectivity and interdependencies within a sample. The ultimate utility of these 3-D datasets depends on the level of detail contained and the relative precision to which the original geometry is preserved in the resultant dataset. Unfortunately, the field-of-view of current high-resolution imaging tools is often much smaller than the region of interest. Extended volume imaging techniques allow multiple, overlapping regions to be collected to reconstruct a volume much larger than the field-of-view with high resolution.

In order to bring the power of Fluorescent protein labeling to 3-D extended volume imaging, Vibratome Assisted Sub-Surface Imaging Microscopy (VIBRA-SSIM) was developed and disclosed in U.S. application Ser. No. 12/188,076, filed on Aug. 7, 2008, which is incorporated by reference as though fully set forth herein.

VIBRA-SSIM preserves fluorescent protein fluorescence and allows for the direct visualization fluorescent proteins. In addition and in contrast to previous techniques, VIBRA-SSIM preserves cellular geometries, doesn't extract cellular components, and allows for more realistic and accurate 3-D reconstructions of large tissue samples.

Some implementations of VIBRA-SSIM require the precise movement of a large, heavy, expensive vibrating microtome that has been coupled to a microscope. Due to the size and weight of the vibrating microtome, precisely and reproducibly positioning it with respect to the microscope objective can be difficult and costly. Moving the microscope with respect to the vibrating microtome can be even more difficult and costly. In order to overcome this engineering challenge and to increase its accessibility/applicability to a larger number of laboratories, the present invention was devised to provide a miniaturized tissue sectioning device and sample positioner that fits within the space reserved for the sample on the microscope stage itself. This modular microscope attachment allows researchers and others to modify an existing microscope to perform volume imaging. As a non-limiting example, the microscope coupled tissue sectioning system of the present invention can be used to modify a Laser Scanning Microscope (LSM) in order to perform VIBRA-SSIM style 3-D extended volume imaging.

(4) Details of the Invention

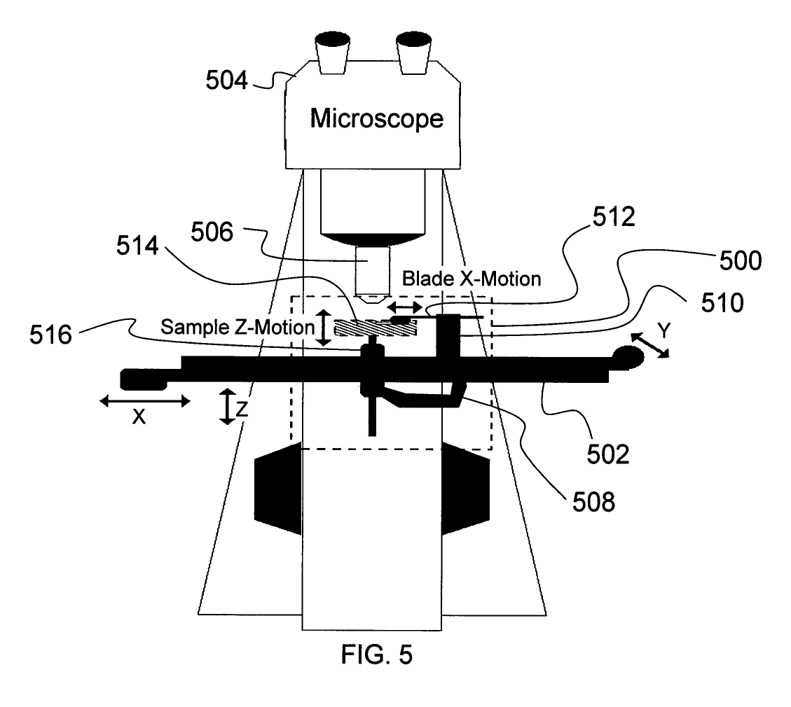

As shown in FIG. 5, the present invention is a microscope coupled (e.g., stage mounted) tissue sectioning system 500 that is small enough to fit within, couple with, or to replace the microscope stage 502 of a pre-existing, commercial microscope 504 of any manufacturer. The microscope can be any suitable microscope, non-limiting examples of which include non-widefield and brightfield microscopes. This will allow for the automation of the entire sectioning and imaging procedure, decreasing the time necessary for the entire process and/or freeing the technician to do other tasks. The present invention will not require any modification to the microscope 504 except for the stage mounting apparatus and possible modification to the control software. As noted above, the system can be stage mounted with a standard microscope stage which allows for a particular type of coupling that is very convenient to set up and cost effect; however, it is to be understood that the present invention is not intended to be limited thereto as any suitable form of coupling with the microscope is envisioned and enabled by the present invention. Rather than building an entire imaging system, the present invention is a more cost-effective microscope stage 502 accessory. By processing the samples, imaging, and sectioning in-place, without changing location, all the procedures can be integrated together, and all the necessary steps can be performed serially, in-place. The present invention provides a time and cost effective method of imaging samples. Since no modification is required of the imaging portion of the microscope 504, the automation technique can use standard microscope objectives 506 and is amenable to any imaging, such as, but not limited to, laser scanning microscopy techniques (including, but not limited to confocal (laser scanning and spinning-disk), and multi-photon microscopy), brightfield or widefield pinhole camera imaging, structured illumination. The device is also compatible with all forms of illumination, excitation, reflection, transmission techniques and will still be compatible with any technique discovered in the future that relies on imaging a sample placed on a planar stage.

Thus, in essence, the present invention provides a device and method of coupling an existing microscope 504 to a tissue sectioning system 500 optically and/or mechanically. The system may be mechanically attached directly to the microscope stage 502 to use the existing imaging path or may be adjacent to the microscope 504 with an optical relay system of lens and/or mirrors to divert the imaging path to the adjacent tissue sectioning system. Although optical/mechanical/electrical attachments may be made, they are not a destructive modification and, therefore, should not void the warranty of the microscope. The imaging path of the microscope 504 may be extended or diverted with other optical elements to add functionality.

Generally speaking, the tissue sectioning system 500 includes a frame 508 for coupling with a microscope 504. The frame 508 is any suitable mechanism or device that operates to couple the components of the sectioning system 500 together and also allows the sectioning system 500 to couple with the microscope 504. As a non-limiting example, the frame 508 is a platform that can rest on the existing microscope stage with a clamp hanging off the side to enable the platform to tighten against the existing microscope stage (or the platform can simply rest within the existing microscope stage). Also included is a sample cutting apparatus 510 that includes a sample cutter 512 for removing a portion of a sample 514. The sample cutting apparatus 510 is operable for causing the sample cutter 512 to engage with the sample 514 by moving the sample cutter 512 to the sample 514, or by moving the sample 514 to the sample cutter 512. As a non-limiting example, the sample cutting apparatus 510 may include a motor that moves the sample cutter 512 relative to the sample 514 (or vice versa) in the x-y axes and, in some cases, the z-axis. This may be accomplished via a motor system the includes a motor or motors with series of slide rails or gearing mechanisms as commonly understood by one skilled in the art. As a non-limiting example, one motor could be connected with the sample cutter 512 via a screw mechanism (with the sample cutter 512 mounted on first slide rails) that will move the sample cutter 512 in the x-axis, while another motor is attached with the first slide rails via a screw mechanism to move the first slide rails with attached sample cutter 512 in the y-axis, while yet another motor is attached with the sample cutter 512 via a screw mechanism to move the sample cutter 512 in the z-axis. Such a motor system for moving an object in x, y, and z directions is commonly known to one skilled in the art and can be applied throughout the present invention.

The sample cutter 512 is any suitable cutting tool, mechanism, or device, that is operable for removing a portion of the sample, non-limiting examples of which include an oscillating blade, a hot wire, an abrasive cutter, a laser, and an aqueous-compatible cutter.

A common implementation of an aqueous compatible tissue sectioning system is the vibrating or oscillating blade tissue sectioning system, often referred to as a vibrating-microtome or “Vibratome”. The vibrating action of the blade as it progresses through the sample allows for clean cutting without distorting the sample. This device consists of a blade at a shallow angle with lateral oscillatory motion that can be traversed in a direction perpendicular to the oscillations. The blade can be constrained to the planar motion by use of mechanical linkages and/or guides. In addition, the sample can be translated in a third axis perpendicular to the lateral motion and the blade translation. The blade can be manufactured of various materials, such as, but not limited to, metal, sapphire, or glass. The sapphire blade allows for sections as thin as 20 micrometers to be removed whereas a metal blade is typically used for sections greater than 50 micrometers. The oscillatory motion is provided by a device such as, but not limited to, a motor, a solenoid, or a piezoelectric stack. In this aspect, the blade is at a fixed height and the tissue sample is moved up by an amount that is then removed by the motion of the blade. In this manner the cut top of the tissue block is always at the same position. Alternatively, the sample is at a fixed location and the blade is brought into contact with the sample, or some combination therebetween.

The tissue sectioning system 500 also includes a sample moving apparatus 516 that operable for causing the sample 514 to align with an imaging path of the microscope (i.e., objective 506) for imaging by the microscope 504. The sample moving apparatus 516 can either move the sample 514 or the imaging path (via mirrors, etc.). As a non-limiting example, the sample moving apparatus 516 includes a motor connected with the sample for moving the sample relative to the imaging path in the z-axis when the frame 508 is connected with the microscope 504.

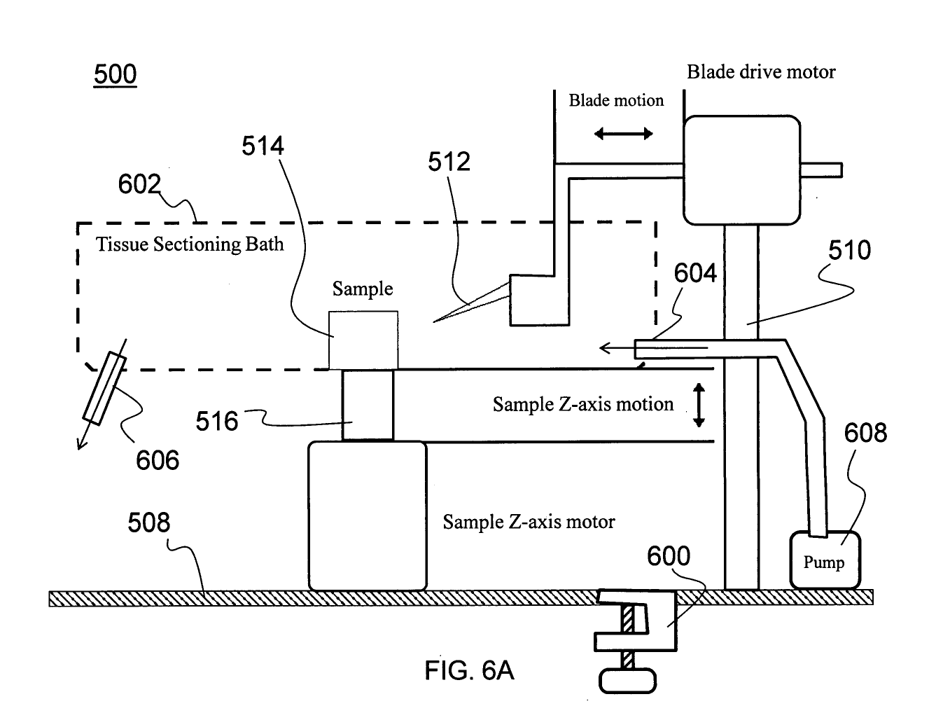

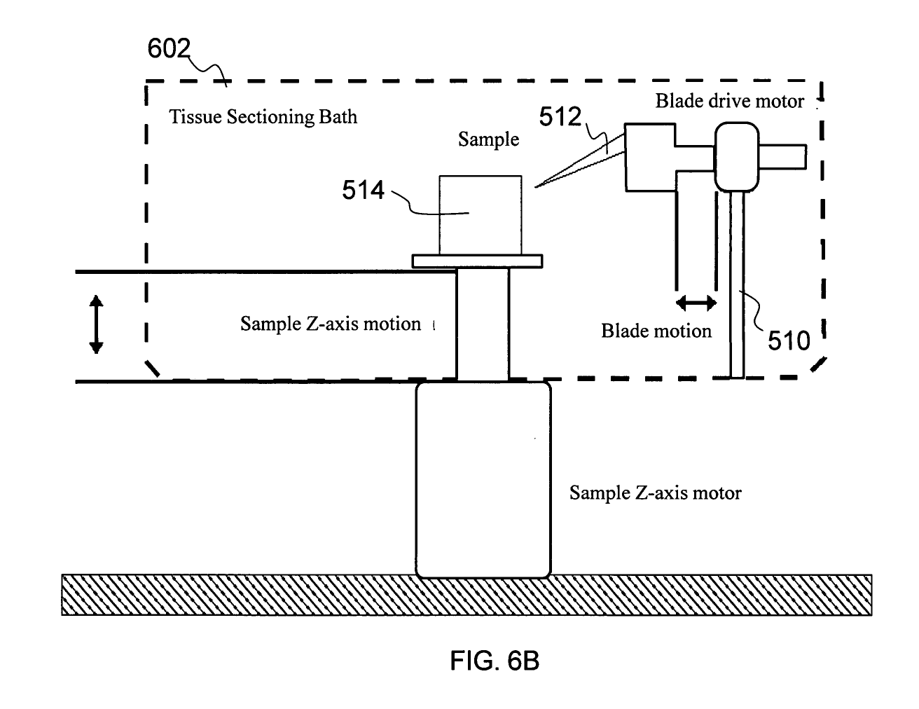

For further understanding, FIG. 6A provides an illustration of a tissue sectioning system 500 according to the present invention. As shown, the frame 508 can be used to connect the sample cutting apparatus 510 and sample moving apparatus 516 with one another. Also as shown, the frame 508 can be formed to fit into or attach with the microscope and/or stage in any suitable manner, a non-limiting example of which includes using a common screw clamp 600 to tighten the frame 508 against the microscope stage. The frame may also be clamped or screwed onto a table that the microscope is also clamped or screwed onto.

In another aspect, the sample 514 is mounted within a bath that holds an aqueous solution completely submerging the tissue to lubricate and cool the cutting blade as well as to keep the aqueous sample hydrated. Thus, the tissue sectioning system 500 also includes an aqueous bath system 602 connected with the frame 508 for mounting the sample 508. The aqueous bath system 602 includes any mechanism or device for maintaining an aqueous solution, a non-limiting example of which includes a tray or container that is capable of holding a solution. Also included are an inlet 604 and an outlet 606 for receiving and expelling the aqueous solution.

A pumping mechanism 608 (e.g., water pump) can be included for pumping the aqueous bath to the sample 514 via the inlet 604 and/or away from the sample 514 via the outlet 606. Thus, the aqueous solution in the bath may have an induced flow to provide temperature control, or to replenish the solution. Mechanical removal of the cut section will be provided to prevent obstruction of the imaging by, for example, the flow of the aqueous solution or some other method to displace the freshly cut section from the imaging path. These sloughed sections can be saved for other studies.

For certain designs and as depicted in FIG. 6B, the entire actuation assembly (i.e., sample cutting apparatus 510) to provide the sample cutter 512 (e.g., blade) oscillation and traversal may be made small enough to fit completely in the bath 602 and be submerged under the aqueous solution. The optical properties of the liquid can be changed to facilitate collection of light. Specifically, the index of the liquid can be increased for liquid immersion microscopy.

By placing the entire aqueous compatible tissue sectioning system 500 within a size compatible with a microscope stage 502, we can also take advantage of the high precision motion control pre-existing on modern motorized microscope stages (these may already exist on the microscope system, or be available as an accessory from the manufacturer or an after-market addition) to do extended volume imaging at the sub-cellular level beyond the field-of-view of a standard microscope objective in a static location. In some cases, the present invention may also be mounted on manual motion microscope stages for manual movement and alignment within the field-of-view or for simple tiling applications that can be done manually. The size of the sample is only limited by the range of the microscope stage motor limits and the physical size of the microscope stage fixture. The speed of extended volume imaging will also be directly related to the microscope motion control technology.

In addition to the simplicity of interfacing to the microscope, the use of existing, precise, motion control technology in the microscope stage handling, and the cost-effectiveness, the small size of the aqueous compatible tissue sectioning system 500 facilitates access for the sample cutter 512 with minimal disturbance of the sample 514. Previous implementations exist that require the sample 514 to be displaced both vertically and laterally with respect to the objective introducing displacement errors that must be corrected in the registration process. In the present invention, the aqueous compatible tissue sectioning system has been reduced in size such that no lateral motion of the sample with respect to the objective is necessary to position the sample cutter 512 or to provide clearance for it. Also for certain implementations of the cutting mechanism, the objective need not be moved vertically relative to the sample 514 if the sample cutter can fit within the working distance of the objective. This minimization of sample 514 movement with respect to the objective leads to simpler, less computationally intensive, and more accurate image registration for the final reconstruction. In many incarnations, a key aspect is the stationary aspect of the cutting device in the z-axis with respect to the objective. This results in a repeatable z-axis, axial, starting point. Rather than moving the blade, the tissue sample 514 is moved closer to the objective (for example, raised in an upright microscope configuration) and the unwanted material is removed by a lateral, x-y planar, cut of the blade. The plane produced by the cut is thus reproducible in its z-axis location, and the starting focal plane, which is just under the surface as described elsewhere in this document, can be reproducibly located.

Thus, in one aspect, the precision motion of the sample cutter 512 with respect to the objective is provided by the precision motion of the microscope stage. The sample cutter 512 is stationary with respect to the stage, and the stage moves, along with the sample cutter 512. In another aspect and also as described above, the sample cutter 512 is moved with respect to the sample 514 and stage via the sample cutting apparatus 510, which can move in the x-y axes.

In order to work with an existing microscope, it may be possible that the control software of the microscope needs to be modified to communicate with the tissue sectioning system (and the sample cutting apparatus) at the appropriate times.

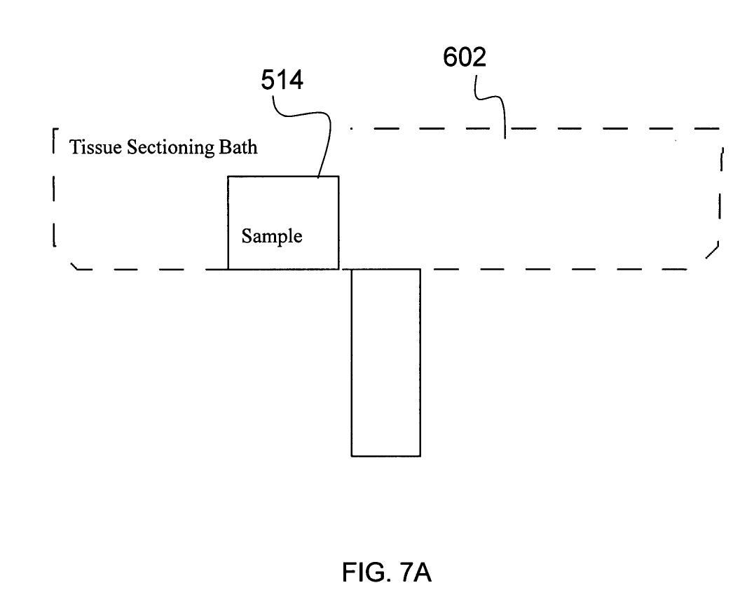

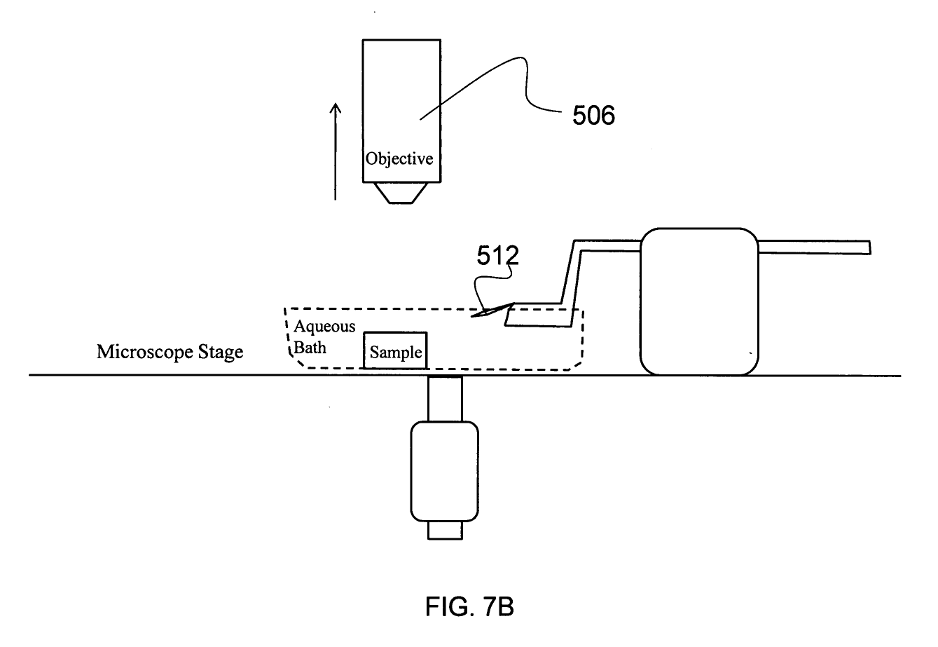

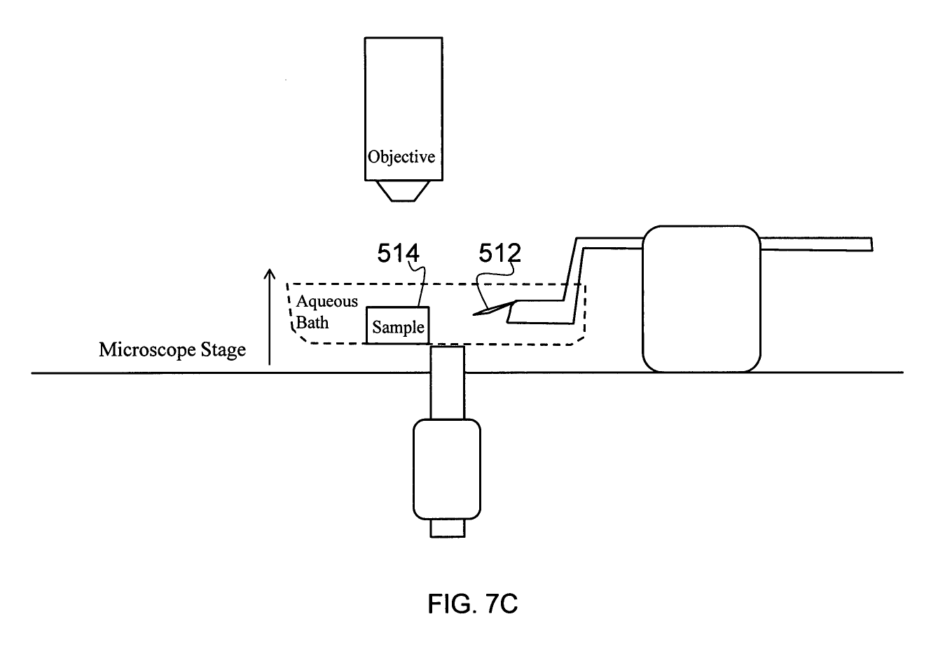

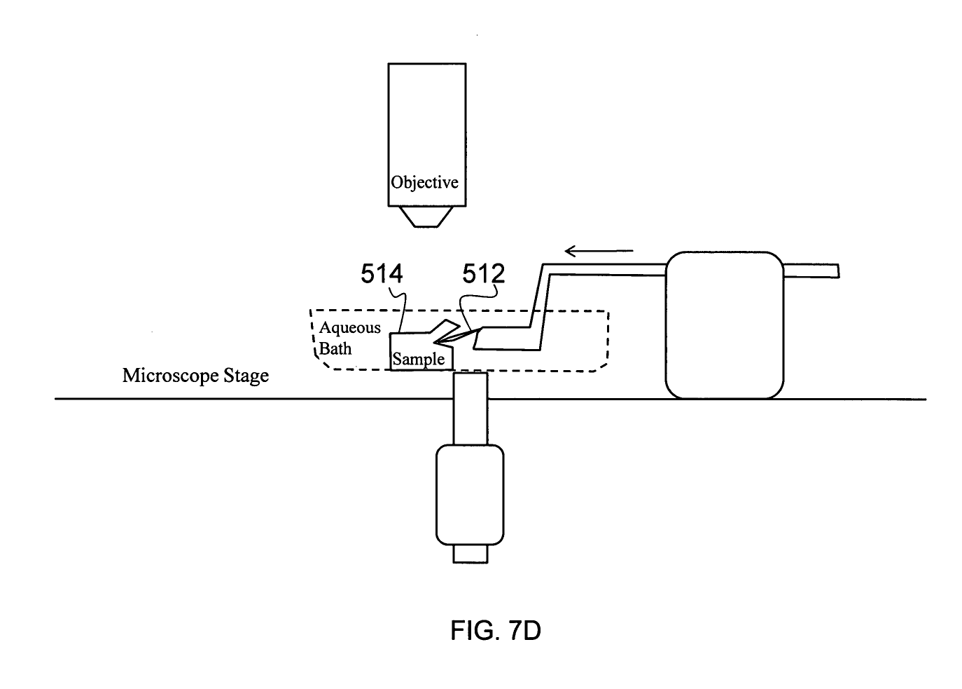

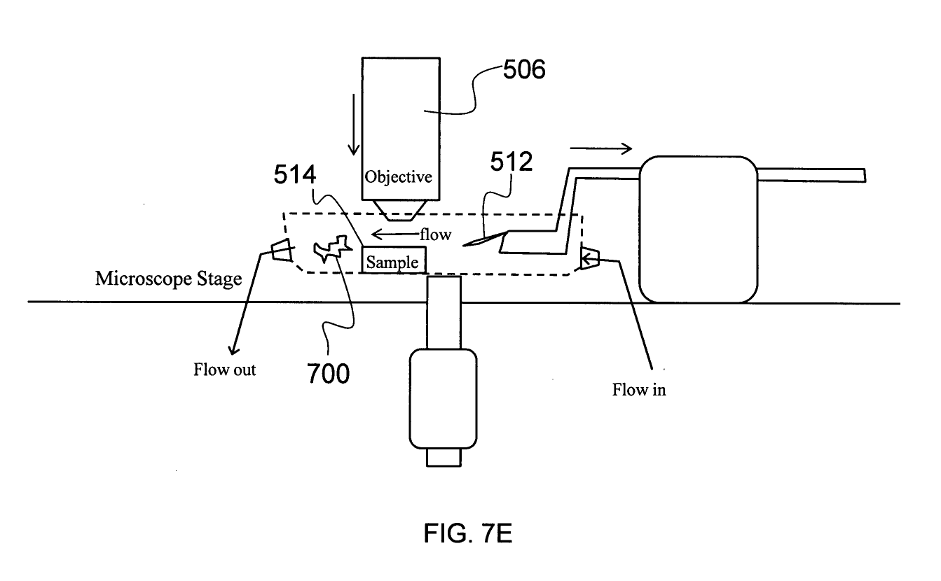

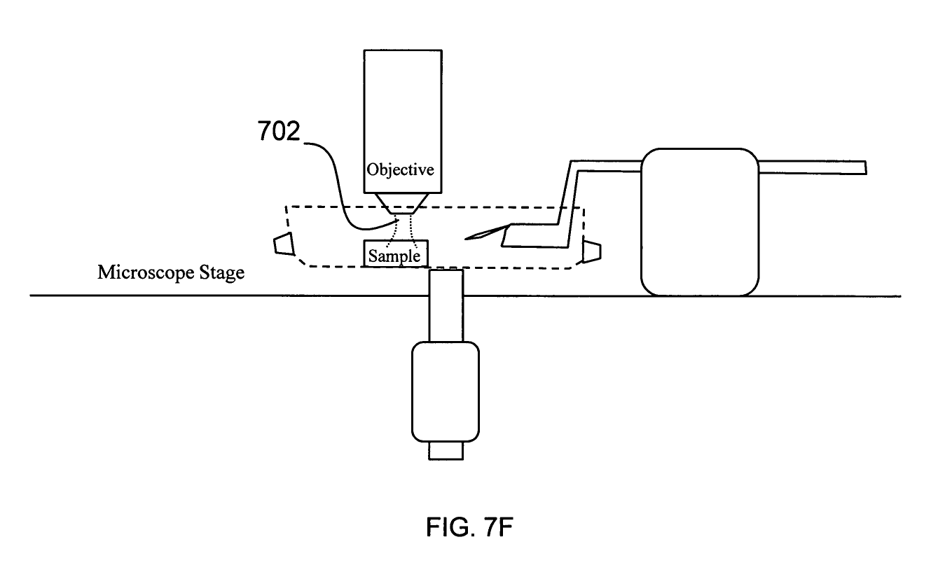

Regardless of any modifications to the control software of any existing microscopes, there are several Acts that can be performed and that are necessary for imaging and sectioning, as follows and as depicted in FIGS. 7A through 7F:
1. First and as shown in FIG. 7A, the embedded tissue sample 514 needs to be mounted into the tissue sectioning system's aqueous bath 602;
2. Optionally and as shown in FIG. 7B, if the sample cutter 512 does not fit within the working distance of the objective 506, the objective 506 is moved (or the stage is moved). For example, the objective could be raised (or the stage lowered).
3. As shown in FIG. 7C, the sample 514 is then raised to a height at which the sample cutter 512 (e.g., blade) is able to cut a section. The sample 514 is raised relative to the microscope stage by a mechanism that is separate and distinct from the z-axis motion provided by the microscope for focusing (either motion of the stage or the objective). Since the sample cutter 512 is kept stationary in the z-axis, this creates a repeatable, fixed, reference focal plane that will be used as the z-axis origin for each iteration. The height of the cut section must be smaller than the height of the optical stack imaged in Act Six (below) so that the subsequent image stacks will be overlapping. In the beginning of the procedure several sections may be cut, or removed without imaging in order to remove sacrificial layers of embedding matrix that do not contain any tissue or to remove regions of tissue preceding the region of interest within the sample.
4. Thereafter and as depicted in FIG. 7D, the top layer of the sample 514 can be sectioned off to create the z-axis origin by keeping the sample 514 stationary and moving the sample cutter 512 across the top of the sample 514. Alternatively, the sample 514 can be moved toward the sample cutter 512 to cause the sample 514 to be cut by the sample cutter 512.
5. As shown in FIG. 7E, the sample cutter 512 is then retracted to its original x-y position. If the objective 506 was raised in Act Two above, the objective 506 is lowered to its starting point, defined as the point when the focal plane of the objective 506 is positioned at an appropriate small distance below the cut surface that will be the top of the imaging stacks. If the objective was not raised in Act Two, it may still need to be adjusted to bring the surface of the sample in focus. The sample layer 700 removed in Act Four is moved from the imaging path via a flow within the aqueous bath that pushes the cut sample layer 700. This flow can be turned on to remove the flow and then turned off, or the flow could be continuously present in all steps. Although FIG. 7E depicts the flow as explicitly introduced only for this act, the invention is not intended to be limited thereto as the flow can also be continuously flowing. The flow could be induced by a mechanism within the aqueous bath, or by an external source by means of some connection, such as to an external pumping mechanism (as depicted in FIG. 6A), via inlet and outlet ports.
6. Thereafter and as shown in FIG. 7F, tiled imaging 702 can be performed in the x-y plane of laterally adjacent optical stacks.
7. The process described above can then be repeated beginning with Act One until a desired total, extended depth (z-axis) has been imaged.
8. Finally, the data can be processed on a computer using publically available methods for compositing the sub-volumes into the fully rendered volume.

As noted above, the sample 514 needs to be embedded in an aqueous matrix or otherwise mounted into the aqueous bath system, which is a container or other item that holds such an aqueous matrix and allows for solution flow through the container. A non-limiting example of such an aqueous matrix is agarose or acrylamide, that is compatible with fluorescent proteins. Other kinds of organic matrices require the sample to be dehydrated, reducing or preventing the fluorescence of the fluorescent proteins. Since the samples themselves are water based, dehydration causes extraction of cellular components, chemical and/or biological changes, and extraction or destruction of imaging labels leading to misinterpretation of the biological structure in the tissue sample. Some of the requirements for the embedding aqueous matrix are detailed below.

The aqueous matrix serves two roles, to hold the sample stable during the cutting process (when cast around the outer surface of the sample) and to support delicate tissue that would normal collapse (when infiltrated into cavities and inter-cellular space)

A key feature of the embedding aqueous matrix is rigidity. For example, the matrix should be able to hold the sample stable during the cutting process. An ideal matrix will not flex or bend during forward force of the cutting process. In many cases the ideal stiffness of the matrix will closely approximate the stiffness of the tissue.

Additionally, the nature of the matrix should be compatible with the tissue and the labels applied or expressed by the tissue. For example, the matrix should not perturb tissue geometry, it should not perturb or extract cellular components and labels, and it should not destroy or reduce the emission of fluorescent proteins. Aqueous based matrix choices are the best for these features because they avoid dehydration steps and organic extraction.

Further, the matrix should be compatible with and not interfere with the form of laser scanning microscopy (LSM) to be used (i.e., low absorbance/scattering in visible light for Confocal LSM or low absorbance/scattering in infrared light for Multiphoton LSM). Very opaque light scattering matrix recipes that significantly block light penetration are not suitable.

Another requirement is that casting and set up of the matrix around the tissue sample must not exhibit features that will destroy or alter the sample. For example, matrix recipes involving high temperatures are not suitable.

The matrix must also securely hold the sample. An ideal matrix will adhere to the tissue or fill into nooks and crannies of the tissue. This tight linkage of the matrix to the tissue sample is essential for the stability of the sample during the cutting process. The hold of the matrix on the sample can be enhanced in a number of ways. For example, soaking the tissue sample in the matrix components prior to allowing matrix solidification can enhance the infiltration of the matrix into the crannies of the tissue surface. Alternatively, once the tissue has been embedded in the matrix, the block of the matrix can be soaked in a cross-linking fixative such as 4% paraformaldyhyde in PBS buffer. This post fixation can crosslink the matrix to the sample and enhance the stability of the hold.

Another requirement is that the matrix must be compatible with and cleavable by the type of sample cutter (e.g., knife) used. Matrix recipes that can not be cut by a metal blade, sapphire knife, or glass blade will be less effective but may be usable if other cutting techniques are employed (e.g. hot wire, etc.).

Further, the matrix should be aqueous buffer permeable. Buffer diffused in to the matrix/sample block helps preserve the tissue by keeping it hydrated, lubricates the blade during cutting, and reduces heat build-up.

Based on the requirements above, there are several matrices that have been found to be desirable for use with the present invention. Non-limiting examples of such suitable aqueous matrices include a low melt agarose (LMA) made up in a physiological appropriate buffer, Gelatin made up in a physiological appropriate buffer, and Acrylamide.

Thus, using an appropriate matrix, the sample can be embedded in the aqueous matrix and then mounted in the aqueous bath system for examination and three-dimensional volume microscopy.

What is claimed is:

1. A microscope coupled tissue sectioning system, comprising:
a frame for coupling with a microscope;
a sample cutting apparatus attached with the frame, the sample cutting apparatus having a sample cutter and being operable for causing the sample cutter to engage with the sample and remove a portion of the sample; and
a sample moving apparatus attached with the frame, the sample moving apparatus being operable for causing the sample to align with an imaging path of a microscope for imaging by the microscope.

2. The microscope coupled tissue sectioning system as set forth in claim 1, further comprising an aqueous bath system connected with the frame for mounting the sample.

3. The microscope coupled tissue sectioning system as set forth in claim 2, wherein the aqueous bath system further includes a flow apparatus for allowing an aqueous bath to flow across the sample and move the portion of the sample that was removed by the sample cutting apparatus out of the imaging path.

4. The microscope coupled tissue sectioning system as set forth in claim 3, wherein the flow apparatus includes an inlet, an outlet, and a pumping mechanism for pumping the aqueous bath to the sample via the inlet and/or away from the sample via the outlet.

5. The microscope coupled tissue sectioning system as set forth in claim 4, wherein the sample cutting apparatus includes a motor system that is operable for moving the sample cutter and sample in a manner selected from a group consisting of moving the sample cutter relative to the sample in the x-y axes and moving the sample relative to the sample cutter in x-y axes.

6. The microscope coupled tissue sectioning system as set forth in claim 5, wherein the sample cutting apparatus includes a motor system that is operable for moving the sample cutter and sample in a manner selected from a group consisting of moving the sample cutter relative to the sample in the z-axis and moving the sample relative to the sample cutter in the z-axis.

7. The microscope coupled tissue sectioning system as set forth in claim 6, wherein the sample moving apparatus is operable for moving the sample relative to the imaging path in the z-axis when the frame is connected with a microscope.

8. The microscope coupled tissue sectioning system as set forth in claim 7, wherein the sample cutter is a cutting tool selecting from a group consisting of an oscillating blade and a hot wire.

9. The microscope coupled tissue sectioning system as set forth in claim 1, wherein the sample cutting apparatus includes a motor system that is operable for moving the sample cutter and sample in a manner selected from a group consisting of moving the sample cutter relative to the sample in the x-y axes and moving the sample relative to the sample cutter in x-y axes.

10. The microscope coupled tissue sectioning system as set forth in claim 1, wherein the sample cutting apparatus includes a motor system that is operable for moving the sample cutter and sample in a manner selected from a group consisting of moving the sample cutter relative to the sample in the z-axis and moving the sample relative to the sample cutter in the z-axis.

11. The microscope coupled tissue sectioning system as set forth in claim 1, wherein the sample moving apparatus is operable for moving the sample relative to the imaging path in the z-axis when the frame is connected with a microscope.

12. The microscope coupled tissue sectioning system as set forth in claim 1, wherein the sample cutter is a cutting tool selecting from a group consisting of an oscillating blade and a hot wire.

13. A method for utilizing a microscope coupled tissue sectioning system, comprising acts of:
mounting a sample in an aqueous bath system;
raising the sample to a height at which a sample cutter is capable of removing a section from the sample;
sectioning off a top layer from the sample to create a z-axis origin;
removing the top layer from the sample;
adjusting an objective lens to bring the sample into focus;
performing tiled imaging in an x-y plane of laterally adjacent optical stacks in the sample to generate tiled imaging data;
repeating the acts of raising the sample through performing tiled imaging until a desired depth in the z-axis has been imaged; and
processing the tiled imaging data to combine the data into a fully rendered volume between the z-axis origin and the desired depth in the z-axis.

14. The method as set forth in claim 13, wherein the act of removing the top layer from the sample further comprises an act of providing an aqueous flow through the aqueous bath system to flush the top layer from the sample.

15. The method as set forth in claim 13, wherein the act of sectioning off a top layer from the sample further comprises an act of cutting off a top portion of the sample using a technique selected from a group consisting of moving a blade across the sample, slicing the sample with a hotwire, abrasion cutting, laser cutting, and aqueous-compatible cutting.
